(19) United States
(12) Patent Application Publication
(10) Pub. No.: US 2025/0379407 A1
(43) Pub. Date: Dec. 11, 2025

(54) DISCHARGE DEVICE FOR DISCHARGING ELECTRIC CURRENTS, AND MACHINE COMPRISING A DISCHARGE DEVICE OF THIS KIND

(71) Applicant: Schunk Carbon Technology GmbH, Bad Goisern (AT)

(72) Inventors: Paul Maas, Bad Ischl (AT); Ludwig Kain, Bad Goisern (AT); Georg Schwaighofer, Russbach (AT)

(21) Appl. No.: 18/876,790

(22) PCT Filed: Jun. 20, 2022
(86) PCT No.: PCT/EP2022/066663

§ 371 Date: Dec. 19, 2024

(51) Int. Cl. H01R 39/26; H01R 39/20; H01R 39/56

(52) U.S. Cl. CPC H01R 39/26; H01R 39/20; H01R 39/56; H04R 2201/10

(57) ABSTRACT

A discharge device for discharging electric currents from a rotor part of a machine having a shaft. The discharge device having an axially displaceable contact element received at least partially in a guide unit and serving to form an electrically conductive sliding contact between a sliding contact surface of the contact element and a shaft contact surface of the shaft, the contact element being connected to the guide unit and/or a retaining element of the machine in an electrically conductive manner and being pre-loaded towards the shaft contact surface by a spring element, the contact element being wetted at least partially by an oily fluid, at least one duct being provided at least in sections of the guide unit and/or of the contact element for the oily fluid, the duct being formed by the guide unit and the contact element.

### CROSS-REFERENCE TO RELATED APPLICATIONS

This patent application is a national stage application of International Patent Application No. PCT/EP2022/066663 filed Jun. 20, 2022, the disclosure of which is incorporated herein by reference.

### TECHNICAL FIELD

This disclosure relates to a discharge device for discharging electric currents from a rotor part of a machine having a shaft, the discharge device comprising an in particular axially displaceable contact element received at least partially in a guide unit and serving to form an electrically conductive sliding contact between a sliding contact surface of the contact element provided for forming the sliding contact and a shaft contact surface of the shaft, the contact element being connected to the guide unit and/or a retaining element of the machine in an electrically conductive manner and the contact element being pre-loaded towards the shaft contact surface by means of a spring element.

### BACKGROUND

Discharge devices for discharging electric currents are known from the state of the art in various embodiments. In particular, it is known to use carbon brushes for discharging low-frequency currents, these carbon brushes being disposed in an axial or radial distribution around a shaft and being connected to a stator via connecting wires. Due to their low electrical resistance, the carbon brushes, which are received in a retaining unit and/or brush holder, allow electrical currents to be discharged directly and can therefore avoid undesired current conduction via bearing points of the shaft, which could lead to surface damage to the bearing bodies or bearing rings due to spot welding.

The term “shaft” is used here as a synonym for the term “rotor part” or “axle”. Therefore, the term “shaft” refers to all rotating machine parts for which currents can be discharged to a stationary stator part and/or machine part of a machine.

Discharge devices are also regularly used in railroad technology, where alternating currents or even an operating current can flow via wheel axles. Discharge devices of this type are described in DE 10 2010 039 847 A1, for example.

Measures to discharge currents are also required for electrical machines in general, for example for motor vehicles. Continuously fluctuating alternating voltages and/or currents and high-frequency current pulses can occur in motor drive shafts or connected transmission shafts and/or other functional components and can also damage bearing points of a rotor shaft or transmission shaft, for which reason discharge devices are regularly required here.

One problem with the discharge devices described and the machines having such discharge devices is the high heat development caused by electrical and mechanical losses, which leads to high thermal loads on both the discharge device and the machine (e.g., motor, transmission). In order to manage this problem to a certain extent, ventilation systems have hitherto been used to dissipate the generated heat. However, such ventilation systems can only partially minimize the thermal load on components. A further disadvantage of such ventilation systems is the drastic increase in the installation space required to integrate such ventilation systems into the machines in question.

### SUMMARY

The object of the disclosure at hand is to overcome the disadvantages of the state of the art mentioned above. In particular, the object of the disclosure is to minimize a thermal load on components when discharging parasitic currents and to simultaneously keep the required installation space to a minimum.

According to the disclosure, this object is attained by a discharge device of the make mentioned above which is characterized in that the contact element is wetted at least partially, in particular at least in the area of its sliding contact surface, using an oily fluid, at least one duct being provided at least in sections of the guide unit and/or of the contact element for the oily fluid, the duct being formed by the guide unit and the contact element.

With the discharge device according to the disclosure, it is ideally possible to discharge capacitively coupled high-frequency voltages (so-called parasitic alternating voltages), which are formed by electric drives due to the power electronics used (pulse width modulation), and at the same time to contain and/or discharge the resulting heat with the aid of the oily fluid. In particular, the present disclosure does not require a special cooling device, such as a ventilation device, to minimize the thermal load. As a result, the design of a machine, such as an electric motor, can be simpler and therefore less expensive and the cooling of the motor can be made more efficient than with the systems known to date. For example, friction losses caused by radial shaft seals, among other things, are also eliminated. In addition-as mentioned above-the overall machine dimensions can be smaller (moment of inertia of the rotating parts is reduced).

As a rule, the oily fluid is motor and/or transmission oil, which is usually present anyway in the engine or transmission in which the discharge device according to the disclosure is provided.

The duct can extend at least along the contact element. This allows indirectly cooling the contact element via the oily fluid flowing through the duct. Moreover, the duct can also be formed in tight installation spaces. Preferably, the duct can extend along the entire length of the contact element.

The duct can be formed by a longitudinal recess in a guide wall of the guide unit and/or a longitudinal recess in an outer wall of the contact element. The longitudinal recess in the contact element and the longitudinal recess in the guide wall can be easily produced. The longitudinal recesses can form the duct for the oily fluid either on their own or together. In particular, it can be provided that a plurality of longitudinal recesses is formed in the guide wall and/or a plurality of longitudinal recesses is also formed in the outer wall, meaning a corresponding number of ducts is made available for the oily fluid.

The outer wall of the contact element can abut against the guide wall of the guide unit. A tolerance can be formed in such a manner between the outer wall of the contact element and the guide wall of the guide unit that the contact element is easily movable. Likewise, the tolerance can be dimensioned such that the contact element cannot become jammed or wedged in the guide unit. At least sections of the outer wall of the contact element therefore abut against the guide wall of the guide unit.

At least sections of the longitudinal recess can have a semicircular cross section, preferably in the manner of a groove. The cross section of the longitudinal recess can generally have any suitable shape. A semicircular cross section is particularly easy to produce. A groove is understood to be an indentation which is long in comparison to its width.

A passage can be formed in the guide unit, a volumetric flow of oily fluid through the duct being able to be limited by means of the passage. The passage can be a simple passage opening, for instance a passage drill hole on a side of the guide unit facing away from the shaft. A cross section of the passage can be smaller in comparison to a cross section of the duct and/or a sum of the cross sections of the ducts. A passage of this kind can be produced particularly easily and with high precision with respect to the duct, meaning a precise volumetric flow of the oily fluid through the duct can be set using the passage.

The groove is preferably continuous. In the duct, a pressure loss, with respect to its length, can arise so that an additional contact pressure can be applied to the contact element on the shaft contact surface of the shaft, which can further reduce contact resistance.

The duct for the oily fluid can open into the space between the shaft and the guide unit. In this embodiment, the heat generated in the contact area between the shaft and the contact element can be immediately dissipated by the flow of the oily fluid.

In a particularly preferred embodiment of the discharge device according to the disclosure, the guide unit is connectable to a stator part of the machine in an electrically conductive manner. This stator part of the machine can, for example, serve as a retaining device for the discharge device. When the current is discharged, it is discharged from the relevant shaft into the contact element and the guide unit of the discharge device. The discharged current then flows into said stator part of the machine in the embodiment described.

Advantageously, the contact element is connected to the guide unit in an electrically conductive manner by means of a, preferably low-impedance, stranded wire, the stranded wire preferably being pressed or stamped into the contact element at one end and preferably being welded or soldered or crimped to the guide unit at the other end. The guide unit is preferably at least partially made of a low-impedance material, in particular metal, preferably aluminum, aluminum alloy, copper and/or brass.

In a particularly preferred embodiment of the discharge device according to the disclosure, the contact element is essentially made of a carbon-metal mixture, in particular of a mixture of graphite and an electrically highly conductive metal, silver preferably being the provided metal at least in the area of the sliding contact surface of the contact element and copper preferably being the provided metal in a rear area of the contact element, the contact element preferably being free of copper in the area of the sliding contact surface. The portion of metal in the contact element is preferably at least 30% by volume. In the area of the sliding contact surface, the contact element is therefore preferably free of copper, as this metal can lead to catalytic changes in the oily fluid in conjunction with the passage of current, which can consequently negatively change the physical properties of this fluid. For this reason, the shaft of the machine according to the disclosure described in more detail below is also free of copper, at least in the area where the shaft contacts the contact element.

In order to keep the system resistance as low as possible under all operating conditions, the resistance of the discharge device according to the disclosure should also be low. The resistance of the entire device can be kept low by using the embodiments described above with low-impedance materials and a contact element made of a metal-carbon mixture. On the other hand, the system resistance is significantly influenced by the voltage drop between the shaft surface and the sliding contact surface of the contact element. This takes up the largest portion of the overall system. It should therefore also be kept low. To ensure this under continuous lubrication, a high specific contact pressure of the contact element on the shaft is advantageous. This value should be at least 10 N/cm². On the other hand, no electrochemical reactions should occur on the contact element in the area of the sliding contact surface in conjunction with the oily fluid. This is ensured particularly by a silver-graphite material in an area of the contact element subject to wear over the entire service life.

Advantageously, the contact element has a recess, in particular a drill hole or slot, in the area of the sliding contact surface. This prevents the contact from floating on the oil film. Advantageously, the contact element is open-pored in the area of the sliding contact surface. This contributes to the suppression of electrical contact losses between the shaft and the contact element and minimizes floating of the contact element on the oil film.

The contact element is typically a pin-or bolt-shaped brush. The sliding contact surface be rectangular, polygonal or circular. The brush is usually manufactured by compression molding and subsequent heat treatment.

Advantageously, the spring element can be a helical spring, one of whose ends abuts preferably against the front face of the contact element opposite the sliding contact surface. With a helical compression spring of this type, it is easy to press the contact element against the shaft using a specific desired contact pressure at all times.

The present disclosure also relates to a machine, in particular an electric drive motor or transmission having a rotor part having a shaft and a discharge device, the contact element of the discharge device contacting the shaft with its sliding contact surface in order to form a sliding contact. The machine according to the disclosure achieves the previously described advantages of a drastically reduced thermal load using a small installation size and uncomplicated design.

In the machine according to the disclosure, the discharge device can be mounted completely in the oily fluid, in particular motor or transmission oil. Preferably, the oily fluid is provided at least in a space between the shaft and the guide unit, which is bridged by the contact element. In this embodiment, the area where the greatest heat is generated, namely the area between the shaft and the contact element, is cooled by the oily fluid.

Advantageously, the contact element is always pressed against the shaft by the spring element using a force of at least 10 N/cm². This minimizes the voltage drop between the shaft surface and the sliding contact surface of the contact element.

As previously explained above, the shaft is preferably essentially free of copper at least in the area where it is contacted by the contact element.

In a preferred embodiment of the machine according to the disclosure, the contact element contacts a front face of the shaft, the contact element preferably being disposed essentially coaxially to the shaft. This type of shaft grounding is preferable for avoiding contact losses, as the axial runout of the rotating shaft is usually low. By positioning the contact element close to the shaft's point of rotation, the circumferential speeds are minimized and the actual running distance over the service life of the contact element is reduced enormously. This has a direct influence on the wear of the contact element, which usually correlates proportionally with the running distance. By minimizing the running distance, the wear of the contact element remains low, as a result of which the loss of force of the spring element over the total wear length of the contact element is also minimal. This makes it possible, for example, to use a low-cost helical compression spring as mentioned above. In addition, the low circumferential speed close to the shaft's axis of rotation reduces the risk of a continuous, electrically insulating lubricating film from forming, which means the contact pressure can be kept lower than would be necessary at high circumferential speeds. Another advantage of the frontal contacting of the shaft close to the axis of rotation is the minimization of the frictional torque due to the small radial distance from the point of rotation. Even with a very high frictional force, the frictional torque as the product of frictional force x running radius remains small. As a result, the friction power remains low in conjunction with the angular velocity (equivalent to the rotational speed) and the system losses remain small.

In a further embodiment of the machine according to the disclosure, the contact element contacts the jacket surface of the surface. In this embodiment, cross section of the contact element is preferably geometrically tapered towards the preferred direction of rotation of the shaft to be contacted in order to achieve suppression of electrical contact losses due to floating between the shaft and the contact element.

As a rule, the discharge device is positioned in a section of the machine where the primary operating temperature is above 50° C.

Further features are shown in the following descriptions of the figures in conjunction with the drawings and the dependent claims. The individual features can be realized alone or in combination with one another.

### BRIEF DESCRIPTION OF THE FIGURES

FIG. 1 shows a first embodiment of a discharge device.

FIG. 2 shows a longitudinal cross section through the discharge device of FIG. 1 in a section of a machine in the contact area between a contact element and a shaft, the contact element being disposed coaxially to the shaft.

FIG. 3 shows a cross-sectional view of the discharge device of FIG. 1.

FIG. 4 shows a frontal view of a second embodiment of a discharge device.

FIG. 5 shows a frontal view of a third embodiment of a discharge device.

FIG. 6 shows a frontal view of a fourth embodiment of a discharge device.

FIG. 7 shows a frontal view of a fifth embodiment of a discharge device.

FIG. 8 shows a frontal view of a sixth embodiment of a discharge device.

FIG. 9 shows a frontal view of a seventh embodiment of a discharge device.

FIG. 10 shows a frontal view of an eighth embodiment of a discharge device.

FIG. 11 shows a frontal view of a ninth embodiment of a discharge device.

FIG. 12 shows a frontal view of a tenth embodiment of a discharge device.

FIG. 13 shows a frontal view of an eleventh embodiment of a discharge device.

FIG. 14 shows a frontal view of a twelfth embodiment of a discharge device.

### DETAILED DESCRIPTION

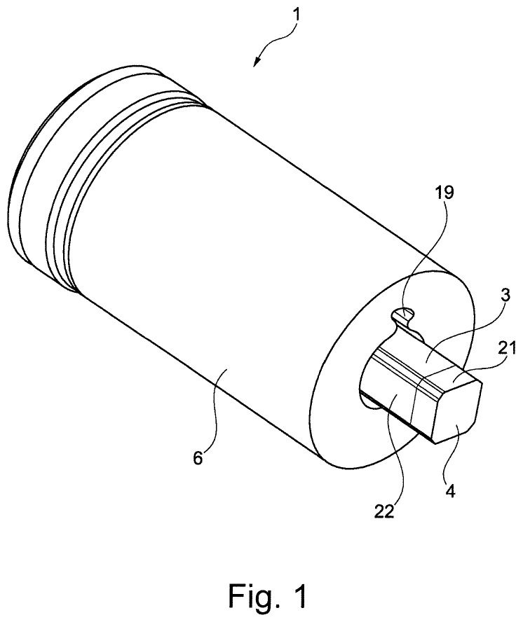

A synopsis of FIGS. 1 to 3 shows a section of a machine 100 according to the invention having a discharge device 1. The machine 100 in the present case is an electric motor which has a rotor part having a shaft 2. The discharge device 1 for discharging electric currents is disposed on a front face 10 of the shaft 2. The discharge device 1 comprises a contact element 3 in the form of a carbon brush for forming an electrically conductive sliding contact between the sliding contact surface 4 of the contact element 3 provided for forming the sliding contact and a shaft contact surface 5 of the shaft 2. The contact element 3 is received in a guide unit 6 in an axially displaceable manner. The guide unit 6 is designed as a cylindrical casing and is located in an also cylindrical recess (not shown) of the machine 100. The contact element 3 is electrically conductively connected to the guide unit 6 by means of a stranded wire 8.

The contact element 3 is pre-loaded towards the shaft contact surface 5 by means of a helical compression spring 9. The contact element 3 is thus subjected to a contact force by the spring 9 in order to form an electrically conductive sliding contact between the sliding contact surface 4 of the contact element 3 provided for forming the sliding contact and the axial shaft contact surface 5 of the shaft 2. On the side of the guide unit 6 facing the shaft 2, the carbon brush 3 protrudes slightly from the guide unit 6 and contacts the shaft 2 at its front face 10. In this context, the contact element 3 is essentially disposed centrally on the front face 10 of the shaft 2 and therefore disposed coaxially to the shaft. As described above, this position is particularly advantageous, as it minimizes wear on the contact element 3.

At the other end of the guide unit 6, it has a cover 11 to which the stranded wire 8 is attached. The spring 9, which pre-loads the contact element 3 towards the shaft 2, is disposed between the cover 11 and the contact element 3.

The guide unit 6 is made of an electrically conductive metal, so that an electrically conductive connection is established between the guide unit 6 and a component group (not shown) of the machine 100, which holds the guide unit 6. In the present exemplary embodiment, the guide unit 6 is made of aluminum.

The stranded wire 8 is also made of a low-impedance material. The stranded wire 8 is pressed into the contact element 3 at one end and connected to the cover 11 at its other end by crimping, resistance welding or soldering. The stranded wire 8 can also be fed through the cover 11 and contacted in another manner.

The contact element 3 has a two-layer structure. In the area of the sliding contact surface 4, the contact element 3 consists of a graphite-silver mixture. This particularly affects a section 21 of the contact element 3. The silver content in this area is approx. 3% by volume. The remaining area of the contact element 3 consists of a graphite-copper mixture. However, the section 21 of the contact element 3 and the shaft 2 are essentially free of copper in order to avoid undesirable reactions with an oil. The contact element 3 is designed as a cylindrical pin. In the present exemplary embodiment, the contact element 3 is pressed against the shaft 2 using a force of approx. 10 N/cm².

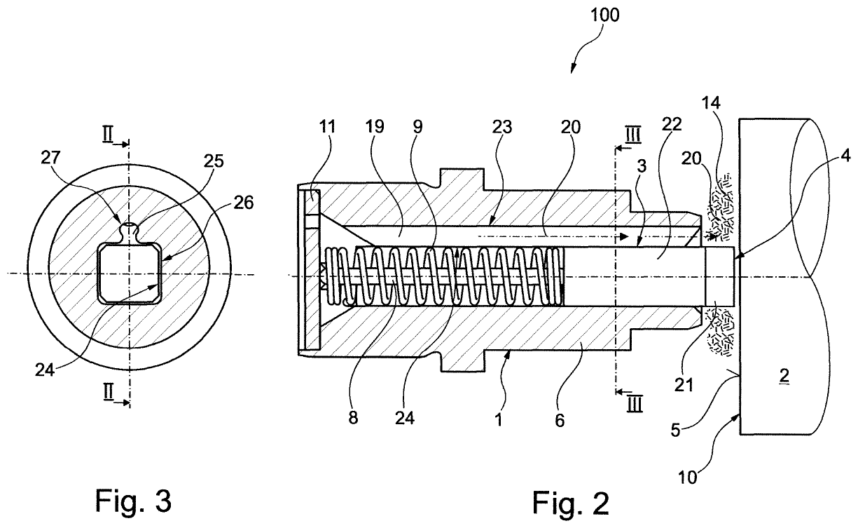

A duct 19 is formed in the guide unit 6, extends in an axial direction from the cover 11 to a space 14 between the guide unit 6 and the shaft 2 and is in open connection with the space 14. As can be seen in FIG. 2, the oil 20 flows from the area of the cover 11 in the direction of the space 14 and pours into it. As a result, section 21 of the contact element 3 is surrounded by the oil 20. In a section 22, the contact element 3 consists of a graphite-copper mixture. In this instance, the stranded wire 8 is connected to the section 22 of the contact element 3 and the guide unit 6 and/or the cover 11 and connects these elements in an electrically conductive manner.

Sections of the duct 19, which is formed in the guide unit 6, are also formed and/or limited by the contact element 3. In particular, the duct 19 is formed by a longitudinal recess 23 in a guide wall 24 of the guide unit 6. The longitudinal recess 23 thus forms a groove 25 in the guide wall 24. The groove 25 is at least partially covered by an outer wall 26 of the contact element 13, so that a cross section 27 of the duct 19, through which the oil 20 flows, is formed in this area between the outer wall 26 and the longitudinal recess 23.

As the oil 20 flows into the space 14, the oil 20 reaches the sliding contact surface 4 and/or the shaft contact surface 5. This “oiling” of the contact element 3 and the shaft 2 achieves optimum cooling in this area. The heated oil then flows from the space 14 into the channels (not shown) of the machine 100. As a result, heat energy is advantageously dissipated from the contact element 3.

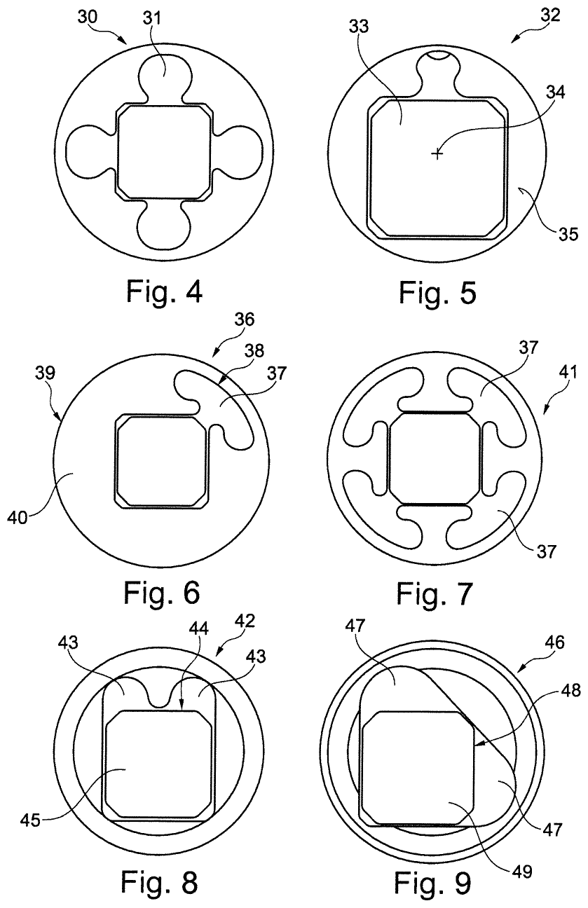

FIG. 4 shows a discharge device 30 in which, in contrast to the discharge device in FIGS. 1 to 3, ducts 31 are formed. The discharge device 30 is symmetrical.

FIG. 5 shows a discharge device 32 which, in contrast to the discharge device in FIGS. 1 to 3, has an asymmetrical arrangement of a contact element 33 relative to a longitudinal axis 34 of a guide unit 35. The contact element 33 can thus be designed having a particularly large cross section.

FIG. 6 shows a discharge device 36 in which, in contrast to the discharge device in FIGS. 1 to 3, a duct 37 is formed having a kidney-shaped cross section 38 which is adapted to an outer edge 39 of a guide unit 40. The cross section 38 can thus be particularly large.

In the illustration of a discharge device 41 in FIG. 7, a plurality of ducts 37 is formed so that a particularly large quantity of oil can be transported through the ducts 37.

The discharge device 42 in FIG. 8 has two semicircular ducts 43 which face an essentially flat outer wall 44 of a contact element 45.

FIG. 9 shows a discharge device 46 in which two ducts 47 are disposed transversely to outer walls 48 of a contact element 49.

FIG. 10 shows a discharge device 50 having a contact element 51 having a polygonal cross section 52. Ducts 54 are formed in a guide unit 55 of the discharge device 50 at each edge 53 of the contact element 51.

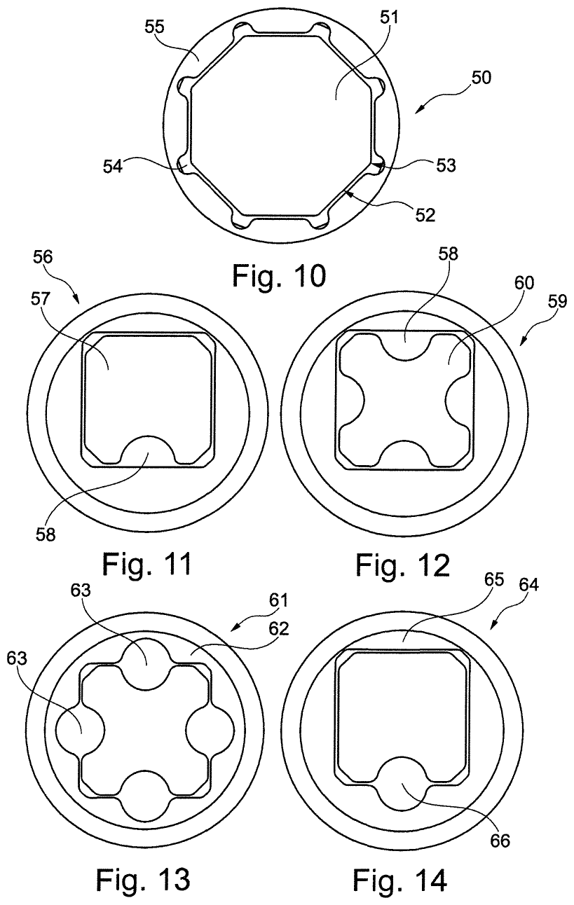

FIG. 11 shows a discharge device 56 having a contact element 57 in which a duct 58 is formed.

In the discharge device 59 shown in FIG. 12, a plurality of ducts 58 is formed in a contact element 60. The contact element 60 is symmetrical.

In contrast to the discharge device in FIG. 12, a part of a duct 63 is also formed in a guide unit 62 in the discharge device 61 of FIG. 13. The discharge device 61 is symmetrical.

FIG. 14 shows a discharge device 64 in which, in contrast to the discharge device of FIG. 11, an individual duct 66 and/or a section thereof is formed in a guide unit 65.

1. A discharge device for discharging electric currents from a rotor part of a machine having a shaft, the discharge device comprising a displaceable contact element received at least partially in a guide unit and serving to form an electrically conductive sliding contact between a sliding contact surface of the contact element provided for forming the sliding contact and a shaft contact surface of the shaft, the contact element being connected to the guide unit and/or a retaining element of the machine in an electrically conductive manner and the contact element being pre-loaded towards the shaft contact surface by a spring element, wherein
the contact element is wetted at least partially, in particular at least in the area of its sliding contact surface, using an oily fluid, at least one duct being provided at least in sections of the guide unit and/or of the contact element for the oily fluid, the duct being formed by the guide unit and the contact element.

2. The discharge device according to claim 1,
wherein
the duct extends at least along the contact element.

3. The discharge device according to claim 1,
wherein
the duct is formed by a longitudinal recess in a guide wall of the guide unit and/or a longitudinal recess in an outer wall of the contact element.

4. The discharge device according to claim 3,
wherein
the outer wall of the contact element abuts against the guide wall of the guide unit.

5. The discharge device according to claim 3,
wherein at least sections of the longitudinal recess have a semicircular cross section.

6. The discharge device according to claim 1,
wherein
the duct for the oily fluid opens into the space between the shaft and the guide unit.

7. The discharge device according to claim 1,
wherein
a passage is formed in the guide unit, a volumetric flow of oily fluid through the duct being able to be limited by the passage.

8. The discharge device according to claim 1,
wherein
the guide unit is connectable to a stator part of the machine in an electrically conductive manner.

9. The discharge device according to claim 1,
wherein
the contact element is connected to the guide unit or a retaining element of the machine by a stranded wire in an electrically conductive manner.

10. The discharge device according to claim 1,
wherein
the contact element is made essentially of a carbon-metal mixture, in particular a mixture of graphite and metal.

11. The discharge device according to claim 1,
wherein
the contact element is a pin-or bolt-shaped brush.

12. The discharge device according to claim 1,
wherein
the spring element is a helical compression spring.

13. A machine, in particular an electric drive motor or transmission having a rotor part having a shaft and a discharge device according to claim 1, the contact element of the discharge device contacting the shaft with its sliding contact surface in order to form a sliding contact.

14. The machine according to claim 13,
wherein
oily fluid, in particular motor or transmission oil, is provided at least in a space between the shaft and the guide unit, the space being bridged by the contact element.

15. The machine according to claim 13,
wherein
the shaft is essentially free of copper at least in the area where the shaft is contacted by the contact element.

16. The machine according to claim 13,
wherein
the contact element contacts a front face of the shaft.

17. The machine according to claim 13,
wherein
the contact element contacts a jacket surface of the shaft.

18. The discharge device according to claim 5,
wherein
the semicircular cross section has a groove.

19. The discharge device according to claim 9,
wherein
the stranded wire is pressed or stamped in the contact element at one end and is welded or soldered or crimped to the guide unit at the other end.

20. The discharge device according to claim 10,
wherein
the total volumetric portion of the metal being at least 30% by volume, silver being the metal provided at least in a front area of the contact area having the sliding contact surface, and copper being the metal provided in a rear area of the contact element, the contact element being free of copper in the area of the sliding contact surface.
